(19) United States
(12) Patent Application Publication
(10) Pub. No.: US 2007/0098596 A1
(43) Pub. Date: May 3, 2007

(54) Handheld microarray reader

(75) Inventors: David P. Fries, St. Petersburg, FL (US); Matthew Smith, St. Petersburg, FL (US)

Correspondence Address: SMITH HOPEN, PA, 180 PINE AVENUE NORTH, OLDSMAR, FL, 34677, US

(73) Assignee: UNIVERSITY OF SOUTH FLORIDA, Tampa, FL (US)

(21) Appl. No.: 11/549,431

(22) Filed: Oct. 13, 2006

Related U.S. Application Data
(60) Provisional application No. 60/727,113, filed on Oct. 14, 2005.

(51) Int. Cl. G01N 21/00

(52) U.S. Cl. 422/82.05

(57) ABSTRACT

A portable, handheld micro-chip array reader capable of responding to selected test species in a field environment. The device incorporates the use of luminescence and/or chemical species in the environment. The solution to the problem of field analysis of trace species is a handheld macro- or micro-array chip-based reader device, which can detect and image small amounts of fluorescence or luminescence emitted from the array chips. The device utilizes night vision technology to effect trace detection of light emanating from array chips (nucleotide or protein. The chips may consist of immobilized capture molecules (oligonucleotides or proteins) which facilitate the binding of a target analyte, or, by using individual, spatially separated wells that enable spatially separated amplification or hybridization to occur in any combination of immobilized or aqueous reaction. The night vision technology is able to detect interaction of the target analyte with the capture molecule via the use of a light emitting (fluorescent or luminescent) label or by photon emitting chemical reaction. Both qualitative and quantitative analyses are within the scope of the invention.

### CROSS REFERENCE TO RELATED APPLICATIONS

This application claims priority to currently pending U.S. Provisional Patent Application 60/727,113, entitled, “Handheld Microarray Reader”, filed Oct. 14, 2005, the contents of which are herein incorporated by reference.

### FIELD OF INVENTION

This invention relates to microarray readers. More specifically, this invention relates portable microarray readers utilizing intensified imaging tubes to enhance the detection of the emission of light or other indicia from a labeled sample.

### BACKGROUND AND SUMMARY OF THE INVENTION

Microarray readers are devices used in biotechnology and other clinical and research settings. The readers utilize a “microarray”, such as can be made by putting a large number of tiny droplets of DNA, including cDNA, and proteins on glass slide or in a multi-well plate. Short pieces of DNA, called probes, are then applied to the DNAs on the slide. Alternatively, in the case of a protein, a molecule that selectively binds a protein of interest, such as an antibody, or fragment thereof, is applied to the sample and allowed to bind under appropriate conditions for specific binding to a target sample. Typically, the probes are fluorescent or luminescent, so they light up when short wavelength light is shone on them (the probes can also be labeled with other substances to reflect or otherwise emanate light when they are scanned). Microarrays can be used, for example, to study how large numbers of genes interact with each other (genes are made of DNA), or how a cell is able to simultaneously control vast numbers of genes.

The probes hybridize to targets on the microarray based upon complentarity under the stringency of the application. The microarrays are then put into a scanning microarray reader that measures the brightness of each fluorescent dot: the brighter the dot, the more probe, and thus the more target. DNA or other biological material, is present, thus allowing quatification of the sample based upon intensity against standards.

Microarrays can be used, for example, to study genomic content, how large numbers of genes interact with each other (genes are made of DNA), or how a cell is able to simultaneously control vast numbers of genes (expression patterns). Different types of microarrays include, but are not limited to, cDNA arrays, oligonucleotide arrays and protein arrays.

A portable, handheld micro-chip array reader capable of responding to selected test species in a field environment. The device incorporates the use of luminescence and/or chemical species in the environment. The solution to the problem of field analysis of trace species is a handheld macro- or micro-array chip-based reader device, which can detect and image small amounts of fluorescence or luminescence emitted from the array chips. The device utilizes night vision technology to effect trace detection of light emanating from array chips (nucleotide or protein. The chips may consist of immobilized capture molecules (oligonucleotides or proteins) which facilitate the binding of a target analyte, or, by using individual, spatially separated wells that enable spatially separated amplification or hybridization to occur in any combination of immobilized or aqueous reaction. The night vision technology is able to detect interaction of the target analyte with the capture molecule via the use of a light emitting (fluorescent or luminescent) label or by photon emitting chemical reaction. Both qualitative and quantitative analyses are within the scope of the invention.

The invention addresses the need for a portable identification and/or quantification system for biological and chemical species in trace and other small quantities. With this device it is possible to obtain, via image and detector probes, information on the presence and/or quantity of a material of interest in situ of in a field situation. This new capability will catalyze new markets, and foster new commercial opportunities by moving diagnostic procedures into the field milieu. Such opportunities include: personalized diagnostics in the doctor's office, or EMT site and the ability to analyze environmental factors in the field without having to transport samples to a lab setting.

The present invention provides an analytical reader. In an embodiment of the present invention the analytical reader includes an illumination source to illuminate a sample, a sample retaining stage, a detector positioned to detect light emitted from an indicia of a sample on said sample stage, an intensified imaging tube (IIT) interposed between said stage and said detector source to intensify the light emitted from the label and a controller to control light modulation at least in part based on a signal from said detector. In certain embodiments the reader includes an integrated power source to facilitate portability of the reader. The IIT may be a passive IIT and an active IIT. The analytical reader may further include a band pass filter disposed between the sample retaining stage and the IIT to facilitate the detection of specific wavelengths of light while excluding unwanted wavelengths. The analytical reader may include an optical lens disposed between the sample retaining stage and the IIT to focus the light emitted from the indicia of the sample onto the IIT or other intermediate structure.

### BRIEF DESCRIPTION OF THE DRAWINGS

For a fuller understanding of the invention, reference should be made to the following detailed description, taken in connection with the accompanying drawings, in which:

FIG. 1 is a schematic diagram of a handheld microarray reader according to the present invention.

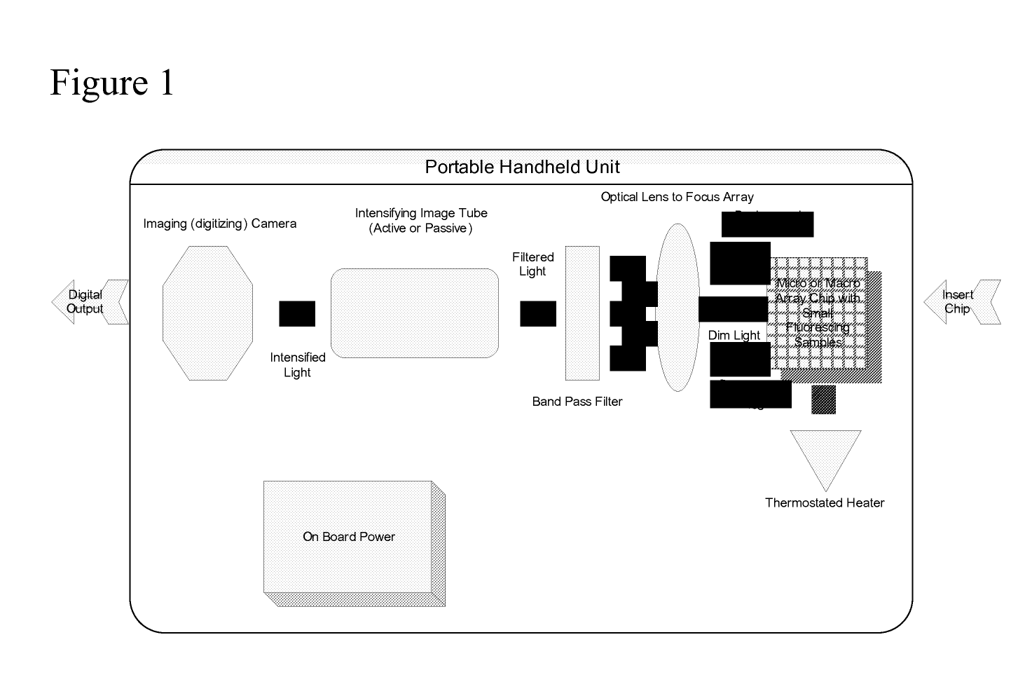

FIG. 2 is an alternative schematic diagram of a handheld microarray reader according to the present invention.

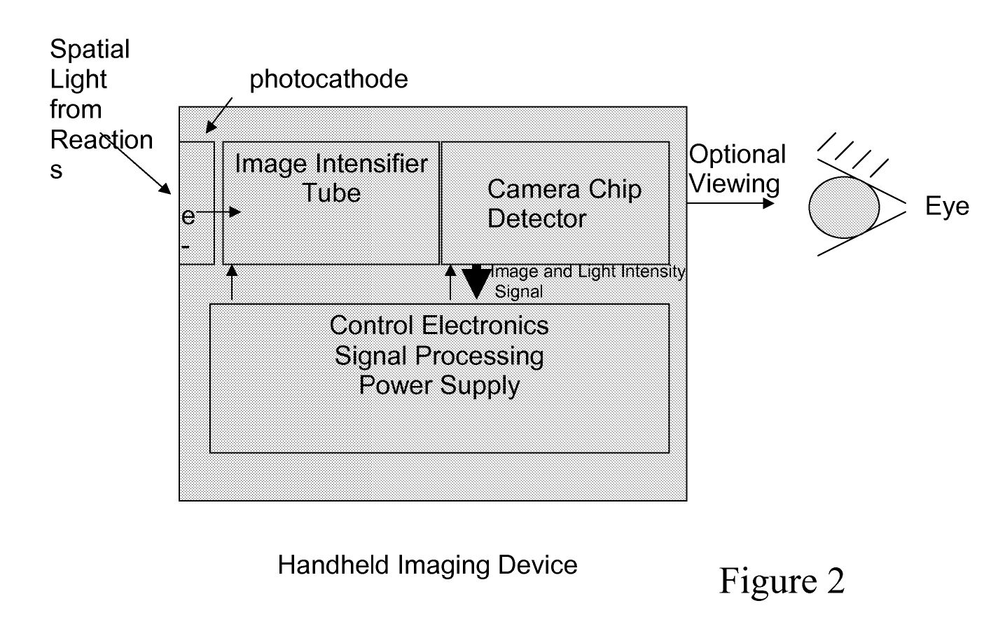

### DETAILED DESCRIPTION OF THE PREFERRED EMBODIMENT

The invention is a handheld microarray reader that allows both imaging of, and light detection from macro- and micro-arrays. The system uses an active or passive intensified imaging tube (IIT) for imaging the spatial array and for detecting the light yield from photon-emitting macro-/micro-arrays. The IIT is combined with band-pass optical filters to detect specific wavelengths of light, optical lenses to focus the array. Portable power supplies, visualization camera(s) to digitize the IIT output micro card roller and a thermostated heater. The self-sufficient system is capable of being used in any portable diagnostic circumstance that could use macro-/micro array technology (hybridization, amplification arrays or combinations thereof). The preferred embodiment if the IIT is a night vision unit of the active or passive kinds, combined with an electronic camera to convert the IIT output to digital data.

The disclosure of all publications cited above are expressly incorporated herein by reference, each in its entirety, to the same extent as if each were incorporated by reference individually.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween. Now that the invention has been described,

What is claimed is:

1. An analytical reader comprising:
an illumination source to illuminate a sample;
a sample retaining stage;
a detector positioned to detect light emitted from an indicia of a sample on said sample stage;
an intensified imaging tube (IIT) interposed between said stage and said detector source to intensify the light emitted from the label; and
a controller to control light modulation at least in part based on a signal from said detector.

2. The analytical reader according to claim 1 further comprising an integrated power source to facilitate portability of the reader.

3. The analytical reader according to claim 1 wherein the IIT is selected from the group consisting of a passive IIT and an active IIT.

4. The analytical reader according to claim 1 further comprising a band pass filter disposed between the sample retaining stage and the IIT to facilitate the detection of specific wavelengths of light while excluding unwanted wavelengths.

5. The analytical reader according to claim 1 further comprising an optical lens disposed between the sample retaining stage and the IIT to focus the light emitted from the indicia of the sample onto the IIT or other intermediate structure.

6. The analytical reader according to claim 1 further comprising a micro card roller integral with the sample stage to facilitate placement of the microarray for detection of individual samples contained thereon.

7. The analytical reader according to claim 1 wherein the illumination source comprises a thermostated heater.

8. The analytical reader according to claim 1 further comprising a visualization camera to digitize or view the output of the IIT.
